(19) United States
(12) Patent Application Publication
(10) Pub. No.: US 2007/0235501 A1
(43) Pub. Date: Oct. 11, 2007

(54) Self-packaging MEMS device

(76) Inventor: John Heck, Berkeley, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/392,821

(22) Filed: Mar. 29, 2006

(51) Int. Cl. A47J 36/02

(52) U.S. Cl. 228/101

(57) ABSTRACT

Microelectronic packages are disclosed. In one aspect, a microelectronic package may include a substrate, a cap layer over the substrate, and a sealed chamber defined between the substrate and the cap layer. The package may include one or more openings to the sealed chamber that are closed by a reflowed material. One or more minutely fabricated structures, such as, for example, MEMS, may be coupled with the substrate within the sealed chamber. One or more interconnect may be included to couple the one or more minutely fabricated structures with a signaling medium that is external to the sealed chamber. Methods of making the microelectronic packages and systems including the microelectronic packages are also disclosed.

### BACKGROUND

1. Field

Embodiments of the invention relate to microelectronic packages for minutely fabricated structures, such as, for example, microelectromechanical systems (MEMS).

2. Background Information

Microelectromechanical systems (MEMS) are commonly packaged in order to protect them from damage and/or shield them from the surrounding environment. Various approaches for packaging MEMS are known in the arts.

One approach is a cap substrate bonding approach in which a die or wafer cap substrate is bonded to a device substrate in order to seal MEMS within a chamber. FIG. 1 shows an enlarged cross-sectional view of a sealed microelectronic package 100. The package includes a device substrate 102, a cap substrate 110, a sealed chamber 106 between the device substrate and the cap substrate, one or more MEMS 104 coupled with the device substrate within the chamber, a ring of sealing material 112 between the device substrate and the cap substrate and around a periphery of the sealed chamber, and interconnects 108 to couple the one or more MEMS with a signaling medium that is external to the package. The cap substrate may include a discrete preformed die cap that may be pick-and-placed and bonded to a wafer substrate or singulated die substrate. Alternatively, the cap substrate may include a wafer cap, such as, for example, a cavity cap wafer, that may be wafer bonded to a wafer substrate and then singulated along with the dice.

Such an approach may have one or more potential drawbacks. One potential drawback is expense. The expense may potentially arise in part from processing the cap substrate with a bonding material and/or from the potentially expensive and/or potentially slow bonding tools that are utilized in the packaging. Another potential drawback is that a significant amount of area may be used for the rings of sealing material, such as, for example, to allow for imperfect alignment during bonding. Representatively, the footprint areas for the rings may be around 150 to 500 micrometers (μm) in width. Yet another potential drawback is that the cap substrate may add significant thickness, such as, for example, around 250 μm, or more, of extra thickness, to the package.

Another approach is a so-called self-packaging approach. FIG. 2A shows an enlarged cross-sectional view of an unsealed microelectronic package 200A. The unsealed package includes a device substrate 202, a deposited cap layer 214, an unsealed chamber 205 between the device substrate and the deposited cap layer, one or more MEMS 204 coupled with the device substrate within the unsealed chamber, and interconnects 208 to couple the one or more MEMS with a signaling medium that is external to the package. The deposited cap layer may be deposited over the substrate using a deposition method, such as, for example, physical vapor deposition (PVD) or chemical vapor deposition (CVD). The deposited cap layer includes openings 216 to the unsealed chamber from the outside of the package. An etchant, solvent, or other material may be flowed or otherwise introduced through the openings in order to remove a sacrificial material from the location of the unsealed chamber and thereby form the chamber and release the MEMS.

The self-packaging approach may have one or more potential advantages compared to the cap substrate bonding approach. One potential advantage is that a bonding tool, which may tend to be expensive, is not required in the self-packaging approach. Instead, the deposited cap layer may be formed over the device substrate by deposition. Another potential advantage is that the footprint area used to seal the deposited cap layer to the device substrate may be significantly less than the footprint area used for the rings of sealing material in the cap substrate bonding approach. There is no need to include additional footprint area to allow for imperfect alignment during bonding. Advantageously, this may allow more dice to be formed per wafer. Yet another potential advantage is that the height of the microelectronic package may be reduced. The deposited cap layer may potentially have a thickness that is substantially less than the thickness of the die or wafer cap substrate.

Deposition has been used to seal the openings in the deposited cap layer and hermetically seal the microelectronic package. FIG. 2B shows a view of a hermetically sealed microelectronic package 200B having a sealed chamber 206 formed by depositing sealing material 218 to close the openings 216 of the unsealed microelectronic package 200A. Conventional deposition methods include PVD, for example sputtering and evaporation, CVD, and spin-on.

However, deposition of the sealing material to seal the openings may have potential drawbacks. As shown in FIG. 2B, one potential drawback is that a portion 220 of the material may be deposited on or otherwise adhere to the MEMS. In the case of spin-on, organics may tend to outgas and adhere to the MEMS. This may tend to adversely affect the performance of the MEMS. Another potential drawback is that the ambient composition and pressure in the chamber of the package may be based, at least in part, on the deposition conditions. This may not always be desirable. In some cases, the deposition temperature may be sufficiently high that it may adversely affect the MEMS.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 shows an enlarged cross-sectional view of a sealed microelectronic package sealed by a cap substrate bonding approach.

FIG. 2A shows an enlarged cross-sectional view of an unsealed microelectronic package according to a self-packaging approach.

FIG. 2B shows a view of a sealed microelectronic package according to a self-packaging approach in which the chamber is sealed by depositing sealing material to close the openings of the unsealed microelectronic package.

FIG. 3A shows an enlarged cross-sectional view of an unsealed microelectronic package, according to one or more embodiments of the invention.

FIG. 3B shows an enlarged cross-sectional view of a sealed microelectronic package having a chamber sealed by reflowing a material to cause the material to close one or more sacrificial material removal openings, according to one or more embodiments of the invention.

FIG. 4 shows an enlarged cross-sectional view of a sealed microelectronic package in which middle portions of interconnects are buried in an insulating layer that is formed over the upper surface of the substrate, according to one or more embodiments of the invention.

FIGS. 5A-5F show a method of making and sealing a microelectronic package, according to one or more embodiments of the invention.

FIGS. 6A-6F show enlarged views of several stages of a method of making and sealing a microelectronic package in which a wettable pad is used to encourage a reflowed material to close an opening and seal a chamber, according to one or more embodiments of the invention.

FIGS. 7A-7L show enlarged views of several stages of a method of making a microelectronic package in which a sacrificial material removal tunnel opening may be closed by reflowing a large reflowable feature so that it avalanches or collapses and closes the tunnel opening, according to one or more embodiments of the invention.

FIG. 8 shows an electronic device, according to one or more embodiments of the invention.

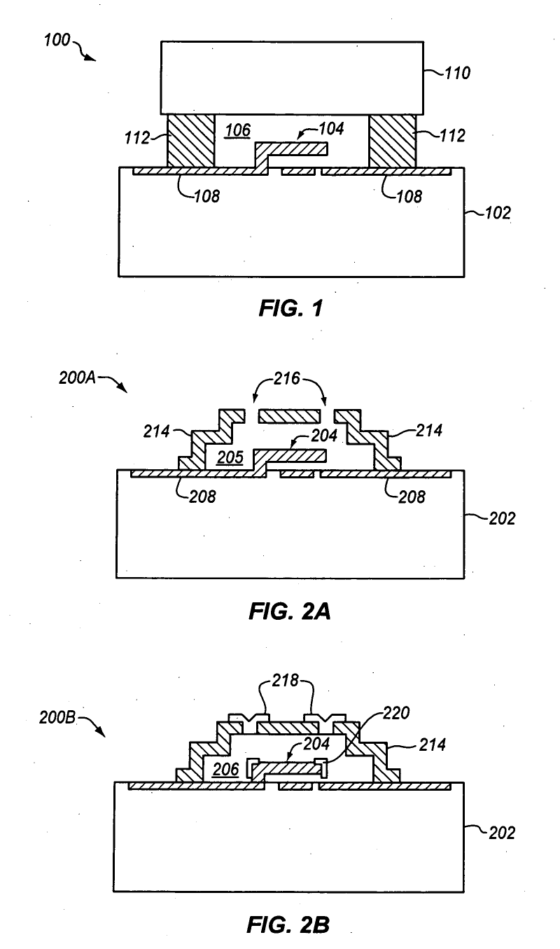

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

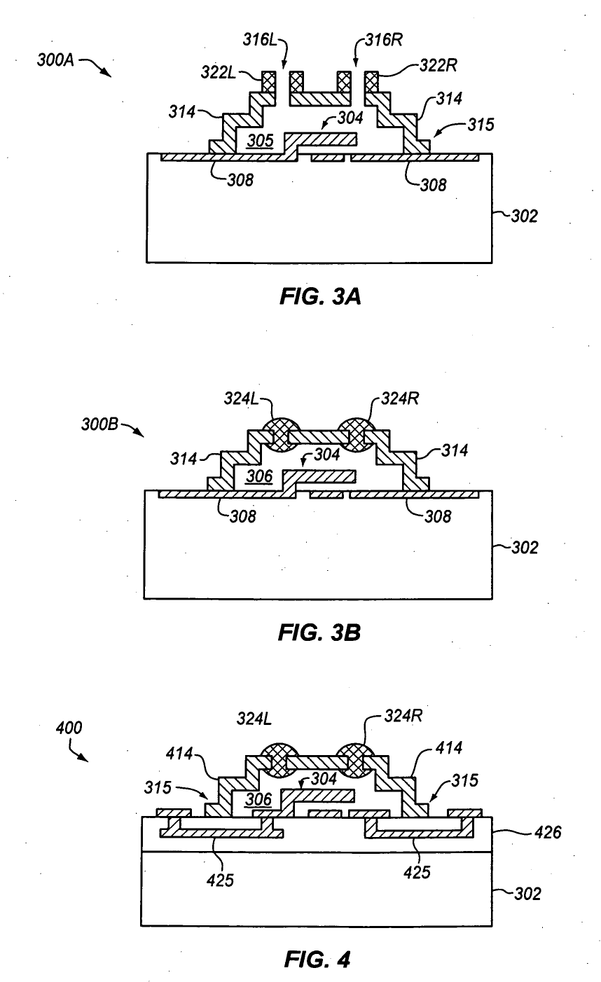

FIG. 3A shows an enlarged cross-sectional view of an unsealed microelectronic package 300A, according to one or more embodiments of the invention. The package may also be referred to herein as a module. The package includes a device substrate 302, a cap layer 314 over the substrate and having one or more sacrificial material removal openings 316L, 316R defined therein, reflowable material 322L, 322R over the cap layer, an unsealed chamber 305 defined between the device substrate and the cap layer, one or more minutely fabricated structures, such as, for example, microelectromechanical systems (MEMS) 304 coupled with the device substrate within the unsealed chamber, and interconnects 308 to couple the one or more MEMS or other minutely fabricated structures with a signaling medium that is external to the unsealed chamber and external to the package. As will be discussed in further detail below, in one or more embodiments of the invention, the unsealed chamber may be sealed by reflowing the reflowable material so that the reflowable material flows into and closes the one or more openings.

The illustrated device substrate 302 may include a workpiece object having portions that have been transformed by a sequence of operations into minutely fabricated structures, such as, for example, the one or more MEMS, microelectronic circuits, other minute configurations, or combinations thereof. In one aspect, the device substrate may include a die. The die may be singulated or otherwise separated from a wafer, for example. Dice are also occasionally referred to as chips, monolithic devices, semiconductor devices, integrated circuits, or microelectronic devices. The die or wafer may include one or more semiconductor materials, such as, for example, silicon, one or more non-semiconductor materials, such as, for example, metals, organic dielectrics, and the like, or a combination of semiconductor and non-semiconductor materials.

The cap layer 314 is “over” the “upper” surface of the device substrate. It should be noted that terms such as, for example, “upper”, “lower”, “top”, “bottom”, “right”, “left”, “vertical”, and the like, are used herein to facilitate the description of the structure of the package as illustrated. It will be evident that the package may be used in a variety of orientations including, but not limited to, an inverted orientation, and various tilted orientations. Further more, the cap layer may be said to be “over” the substrate regardless of whether the layer is vertically above or below, or tilted relative to the substrate.

The cap layer or lid layer may include a layer that may be deposited or otherwise formed over the upper surface of the substrate. As will be explained in further detail below, when the cap layer is formed over the substrate a sacrificial material is generally positioned over the one or more minutely fabricated structures, such as, for example, the one or more MEMS, in the general location of the chamber. The cap layer includes a first unsupported portion that is not in direct contact or abutment with the substrate and a second supported, sealing portion 315 in direct contact or abutment with the substrate. The unsupported portion may be deposited over the sacrificial material, whereas the supported, sealing portion may be deposited directly on the substrate with no sacrificial material disposed therebetween. The supported, sealing portion of the cap layer may form a seal, potentially a hermetic seal, with the substrate. Often, the footprint area used to seal the cap layer to the device substrate may be significantly less than the footprint area used for rings of sealing material in a cap substrate bonding approach, although the scope of the invention is not limited in this respect.

Examples of suitable materials for the cap layer include, but are not limited to, metals, semiconductor materials (for example polysilicon), oxides of semiconductor materials (for example oxides of silicon), nitrides of semiconductor materials (for example nitrides of silicon), oxynitrides of semiconductor materials (for example oxynitrides of silicon), and the like, and combinations thereof. Examples of suitable metals include, but are not limited to, aluminum, copper, titanium, tungsten, chromium, and the like, and alloys, stacks, and other combinations thereof. However the scope of the invention is not limited to just these materials. Other materials may also optionally be used. Other examples of materials that may optionally be used for the cap layer include, but are not limited to, organic materials, such as, for example, plastics, glasses, ceramics, and the like, and combinations thereof. The scope of the invention is not limited to any known material for the cap layer. Notice that either conductive or insulating materials may optionally be used. If conductive materials are used, alternate interconnect structures including buried portions may optionally be used, as discussed further below.

The cap layer may have a sufficient thickness to provide mechanical support and to provide a seal, potentially a hermetic seal, for the chamber. The thickness may depend upon various factors, such as, for example, the properties of the material of the cap layer, the size of the chamber, the pressure in the chamber, and the like. Often, for materials such as, for example, metals, oxides of silicon, and nitrides of silicon, a sufficient thickness of the cap layer may range from at least about 0.5 microns to about 25 microns, or thicker, although the scope of the invention is not limited in this respect. In some cases, the thickness of the cap layer may range from about 1 micron to about 10 microns, although the scope of the invention is not limited in this respect. The scope of the invention is not limited to any known thickness of the cap layer.

The particular illustrated cap layer has a multi-tiered or stair-stepped shape, although the scope of the invention is not limited in this respect. The tiers may optionally be omitted. For example, in various alternate embodiments of the invention, the cap layer may have a flat top and vertical sides so that the cross-section of the chamber is approximately square or rectangular, or else the cap layer may have a curved shape so that the cross-section of the chamber is section of a sphereoid or ellipsoid. These are just a few examples. The scope of the invention is not limited to any known shape of the cap layer.

The one or more sacrificial material removal openings 316L, 316R are defined or housed in the cap layer. In the illustrated embodiment two openings are included, namely a left opening 316L and a right opening 316R, although the scope of the invention is not limited in this respect. A single opening or more than two openings may also optionally be used in alternate embodiments of the invention. In one or more embodiments of the invention, two or more openings may be included and dispersed or spread-out over the location of the chamber to facilitate access to different portions of the chamber, although the scope of the invention is not limited in this respect.

Each of the openings may span an entire thickness of the cap layer so that each of the openings may provide a point of entry into the chamber from outside the chamber or outside the package. As will be explained in further detail below, a sacrificial material removal fluid, such as, for example, a gas, plasma, or liquid solvent or etchant, may be introduced through each of the one or more sacrificial material removal openings to etch, dissolve, or otherwise remove the sacrificial material from around the minutely fabricated structures to release them and form the chamber. In the illustrated embodiment, the MEMS has already been released and the chamber has already been formed.

Examples of suitable shapes for the openings include, but are not limited to, circles, squares, rectangles, ellipsoids, and elongated slits, although the scope of the invention is not limited in this respect. In one or more embodiments of the invention roughly square or rectangular openings may be used due at least in part to relative ease of fabrication, although the scope of the invention is not limited in this respect.

The openings may have a sufficient size to allow entry of the fluid, removal of the fluid and the sacrificial material, and to allow closure by reflow of a material as described in further detail below. For example, in one or more illustrative embodiments of the invention, the openings may include roughly rectangular openings having dimensions in the range of about 0.1 to 25 microns high by 1 to 1000 microns wide, or in the range of about 1 to 5 microns high by 10 to 100 microns wide, although the scope of the invention is not so limited. Other dimensions are also suitable.

Between the device substrate and the cap layer is the unsealed chamber. Coupled with the device substrate, within the chamber, are the one or more minutely fabricated structures, such as, for example, the one or more MEMS. In the following description and claims, the terms “coupled” and “connected,” along with their derivatives, may be used. These terms are not synonyms for each other. Rather, in particular embodiments, “connected” may be used to indicate that two or more elements are in direct physical contact with each other. “Coupled” may mean that two or more elements are in direct physical, electrical, and/or thermal contact. However, “coupled” may also mean that two or more elements are not in direct contact with each other, but yet still cooperate or interact with each other, such as, for example, through intervening elements.

As used herein, the term “MEMS” may be used to refer to either a single microelectromechanical system or multiple microelectromechanical systems. As used herein, the terms “microelectromechanical systems” and “MEMS” may encompass microoptoelectromechanical systems (MOEMS) that include an optical component, as well as bioMEMS. MEMS are occasionally known as micromachines (for example in Japan), or micro systems technology devices (for example in Europe). As used herein, the terms “microelectromechanical system” and “MEMS” are intended to encompass at least those devices referred to by the terms micromachine and/or micro systems technology device.

The MEMS generally represent miniaturized devices having three-dimensional structure. The MEMS may include minutely fabricated and structured transducers. For example, the MEMS may include electrically activated moving parts. The MEMS are minute and miniature. In one or more embodiments of the invention, each of the one or more MEMS may have a dimension that is less than a millimeter (mm, one thousandth of a meter), and often (but not always) more than about a micrometer (μm, one millionth of a meter). Examples of suitable MEMS, accordance to various embodiments of the invention, include, but are not limited to, switches, tunable switches, cantilever beams, cantilever beam arrays, resonators, film bulk acoustic resonators (FBARs), FBAR filters, varactors, radio-frequency MEMS, hinged mirrors, pressure sensors, tunable capacitors, inertial sensors, and combinations thereof. Other types of MEMS are also suitable. The illustrated MEMS includes a cantilever beam and contact plate. A dimension of the MEMS, such as a width of the cantilever beam and/or contact plate, may be less than about a millimeter and more than about a micrometer. Not all dimensions have to be sized so small. For example, another dimension of the MEMS, such as the length of the cantilever beam, may optionally be longer than a millimeter. The invention is not limited to the illustrated MEMS. As discussed above, other MEMS are also suitable.

The scope of the invention is not limited to sealing MEMS in the chamber. Other minute materials and devices may also or alternatively optionally be included in the chamber. Examples of other suitable minute structures that may be included in the chamber include, but are not limited to, other micro-fabricated or nano-fabricated structures, such as, for example, microwires, nanowires, micropowders, nanopowers, nanodevices, and other minutely fabricated structures that may benefit in some way from being sealed in the chamber.

As viewed, the MEMS are physically attached to the upper surface of the device substrate and electrically connected with the interconnects of the substrate. For ease of illustration and explanation, in the illustrated embodiment, only two interconnects are shown, including a first interconnect on the left, and a second interconnect on the right, although the scope of the invention is not limited in this respect.

The interconnects may include electrically conductive materials and/or structures to provide a signaling medium and/or path to electrically couple the MEMS with an external signaling medium that is external to the chamber and to the package. Metals are commonly employed in the interconnects due, at least in part, to their high conductivities. The term “metal” may refer to an alloy, stack of different metals, or other metal mixture, as well as a pure metal. Suitable metals include, but are not limited to, aluminum, copper, gold, solders, and combinations thereof. Electrically conductive materials or conductors other than metals are also suitable. For example, the interconnects may include a doped polysilicon, doped single-crystal silicon, or refractory metal silicide. Combinations of such conductive materials are also suitable.

The interconnects may include lines, traces, or other paths of conductive interconnect material, such as, for example, one or more metals, between conductors inside the chamber, and conductors outside the chamber, such as, for example, conductive pads. Each of the conductive paths has a first terminal end or portion and a second terminal end or portion. In particular, the right interconnect may include a first terminal end outside the package, and a second terminal end inside the chamber, for example, coupled with the MEMS. Likewise, the second interconnect includes a first terminal end outside the chamber, and a second terminal end inside the chamber, for example, coupled with the MEMS.

Middle portions of the conductive paths are disposed between the terminal portions. In the illustrated embodiment, the supported, sealing portion 315 of the cap layer directly contacts or abuts the middle portion of the conductive paths. This may be appropriate when the cap layer is sufficiently insulating to prevent a short or other electrical coupling with the cap layer.

Conductive pads or other conductive contact structures may be included outside of the chamber over the upper surface of the substrate and may be coupled with the first terminal ends of the conductive paths, although this is not required. The conductive pads or the first terminal ends outside of the chamber and accessible from the outside of the package may be used to connect or couple the package with an external signaling medium. Examples of suitable external signaling mediums include, but are not limited to, wirebonds, leads, circuits, printed circuits, printed circuit boards, circuit boards, and other portions of electronic devices or electronic systems in which the package is included, to name just a few examples.

In one or more illustrative embodiments, wirebonding may be used to couple the package with the external signaling medium. For example, a solder ball and thin gold wire, for example having a diameter of about 30 mm, may be used as a package lead to connect to conductive pads or to the first terminal ends. However, the scope of the invention is not limited in this respect.

Referring again to FIG. 3A, the reflowable material 316L, 316R is included over the cap layer. The reflowable material may include a material that may heated to a reflow temperature at which the material may reflow including assuming flow characteristics similar to those of a liquid and changing shape. Examples of suitable reflow materials include, but are not limited to, metal reflow materials and polymeric reflow materials. Examples of suitable metal reflow materials include, but are not limited to, solders, indium alloys, gallium alloys, and combinations thereof. Examples of suitable solders include, but are not limited to, tin-lead solders, gold-tin solders, silver-tin-copper solders, other solders, and combinations of solders. Examples of suitable indium and gallium alloys include, but are not limited to, alloys including one or more intermetallic compounds formed by heating a past or slurry of liquid gallium and/or indium along with particles of one or more metals capable of reacting with the gallium and/or indium to form one or more intermetallic compounds. Suitable examples of such metals include, but are not limited to, nickel, copper, silver, antimony, cobalt, gold, platinum, and combinations thereof. Examples of suitable polymeric reflow materials include, but are not limited to, liquid crystal polymers, and other thermoplastic polymers. Viscous materials, such as, for example, waxes, which may be heated to a softening or melting point and thereafter cooled to a socap may also potentially be used.

As shown, in one or more embodiments of the invention, the reflowable material may optionally include multiple reflowable features, although the scope of the invention is not limited in this respect. In the illustrated embodiment, two reflowable features are shown, namely a left reflowable feature 322L and a right reflowable feature 322R. In the illustrated embodiment, the reflow features optionally include rings, which in cross-section are each illustrated as two rectangles. As shown, the height of the rectangle may optionally be greater than the width in order to promote reflow into the opening, although the scope of the invention is not limited in this respect. The scope of the invention is not limited to just two reflowable features. In alternate embodiments a single reflowable feature or more than two reflowable features may optionally be used.

In one or more embodiments of the invention, a reflowable feature or set or group of reflowable features may optionally be included for each sacrificial material removal openings, although the scope of the invention is not limited in this respect. Each reflowable feature or set or group of reflowable features may optionally be included proximate a corresponding sacrificial material removal opening, although this is not required. For example, as shown in the illustrated embodiment, the left reflowable feature 322L is proximate the left opening 316L and the right reflowable feature 322R is proximate the right opening 316R. As used herein, a reflowable feature is proximate an opening when reflow of the feature may cause reflowed material to reflow into the opening. If the reflowable feature is not proximate the opening then reflow may tend to cause a bead to form on the surface of the cap layer rather than flowing into the opening. A larger reflowable feature may be proximate an opening even at a greater separation distance because the larger reflowable feature may flow a farther distance to the opening.

As shown, in one or more embodiments of the invention, reflowable features may include rings of reflowable material around a periphery of an opening or otherwise surrounding the opening. As used herein, the term “ring” does not necessarily imply circularity. The ring may have a circular, rectangular, square, polygonal, curvilinear, or other closed plane shape. Although a circular ring may offer certain advantages especially for a circular opening. However, the scope of the invention is not limited to using rings. Other suitable reflowable features include, but are not limited to, groups or sets of discrete reflowable features around an opening. Still other suitable reflowable features include, but are not limited to, a single discrete reflowable feature, such as, for example, a solder ball or solder mound, at or around the side or edge of an opening. Yet another suitable reflowable feature includes a wall of solder material at or around at or around at least a portion of one or more sides or edges of an opening. These are just a few illustrative examples. The scope of the invention is not limited to just these examples.

The amount of reflowable material included in the one or more reflowable features around an opening should be sufficient to close the opening. Additional material may optionally be included to at least partially or completely fill the opening, although this is not required.

FIG. 3B shows an enlarged cross-sectional view of a sealed microelectronic package 300B having a sealed chamber 306 that is sealed by reflowing the reflowable material of FIG. 3A to cause the reflowable material to flow at least partially into and close the one or more sacrificial material removal openings, according to one or more embodiments of the invention. The reflowable material may be reflowed by heating the material to the reflow temperature at which the material may melt or at least soften and begin to change shape. Surface tension forces may pull the reflowing material inward on itself to form a sphereoid or bead and draw the reflowing material at least partially into the opening. The reflowed material may then be cooled to solidify the material, or at least make the material sufficiently viscous to seal the chamber. As shown, the hardened reflowed material may include a sphereoid or bead that closes the opening. In the illustrated embodiment, the reflowed material has flowed into and fills the openings, although this is not required. The center of the reflowed material may be inside the opening, although this is not required.

Closing the openings may seal the chamber. Sealing the chamber may tend to prevent, or at least reduce, the exchange of materials between the chamber and an environment surrounding the chamber. For example, the seal may tend to reduce the entry of ambient air, water (for example moisture), or other materials to the chamber, reduce the pressurization of a vacuous chamber, reduce the loss of pressure from a pressurized chamber, and/or limit the escape of a noble gas, other inert material, or other material that is included in the chamber. In one or more embodiments of the invention, the chamber may include a hermetically sealed chamber, and the cap layer may include a hermetic seal for the chamber, although this is not required. The hermetically sealed chamber may be generally airtight or impervious to water (for example moisture), air, or another material that may be present in the environment surrounding the chamber or package. This may help to protect structures in the chamber from stiction, corrosion (for example oxidation), or other potential problems associated with air or moisture, for example.

Accordingly, the package may be sealed without using a cap substrate. Instead, a cap layer may be deposited or otherwise formed over a substrate. Also, the package may be sealed without needing to use a bonding tool, which may potentially be expensive and/or slow. Embodiments of the invention may help to reduce the costs of packaging. Furthermore, the footprint area used to seal the cap layer to the device substrate may be significantly less than the footprint area used for rings of sealing material in a cap substrate bonding approach. Advantageously, this may allow more dice to be formed per wafer. The use of the cap layer instead of the cap substrate may also potentially allow the height of the microelectronic package to be reduced, although the scope of the invention is not limited in this respect.

Furthermore, the chamber has been sealed without needing to deposit material into the opening to seal the opening or spin-on material into the opening to seal the opening. This may help to avoid depositing or otherwise adhering portions of the sealing material in the chamber or on minutely fabricated structures or other sensitive materials included in the chamber. This may be advantageous, since such deposits or other adhering portions may tend to adversely affect the performance of the MEMS or have other adverse affects. Additionally, the ambient composition and pressure in the chamber need not be based on deposition conditions used to deposit material to seal the sacrificial material removal openings. This may allow greater flexibility in the atmosphere and/or pressure in the sealed chamber.

FIG. 4 shows an enlarged cross-sectional view of a sealed microelectronic package 400 in which middle portions 425 of the interconnects 308 are buried in an insulating layer 426 that is formed over the upper surface of the substrate 302, according to one or more embodiments of the invention. For example, at least a portion of the interconnects directly below the supported, sealing portion 315 of the lid layer may be buried in the insulating layer. This may be appropriate when conductive materials, such as, for example, metals, are used for the cap layer, in order to prevent, or at least reduce the risk of, electrical shorting or coupling of the interconnects with the cap layer. The insulating layer may include an insulating or dielectric material. In one aspect, the insulating layer may include an oxide of silicon, such as, for example, silicon dioxide (SiO2). Other insulating materials or dielectrics, such as, for example, polymeric foams or other organic insulating materials may also optionally be used.

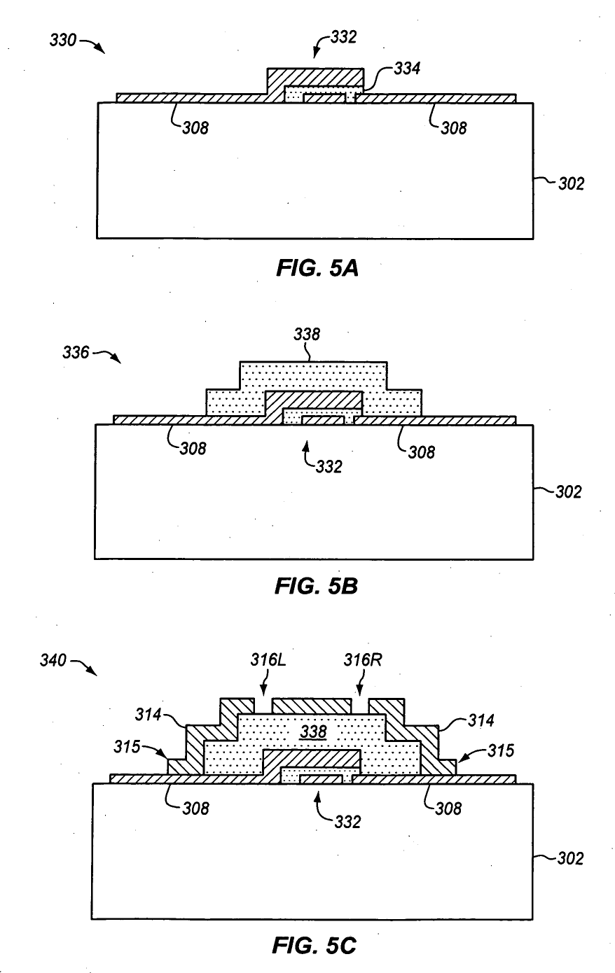

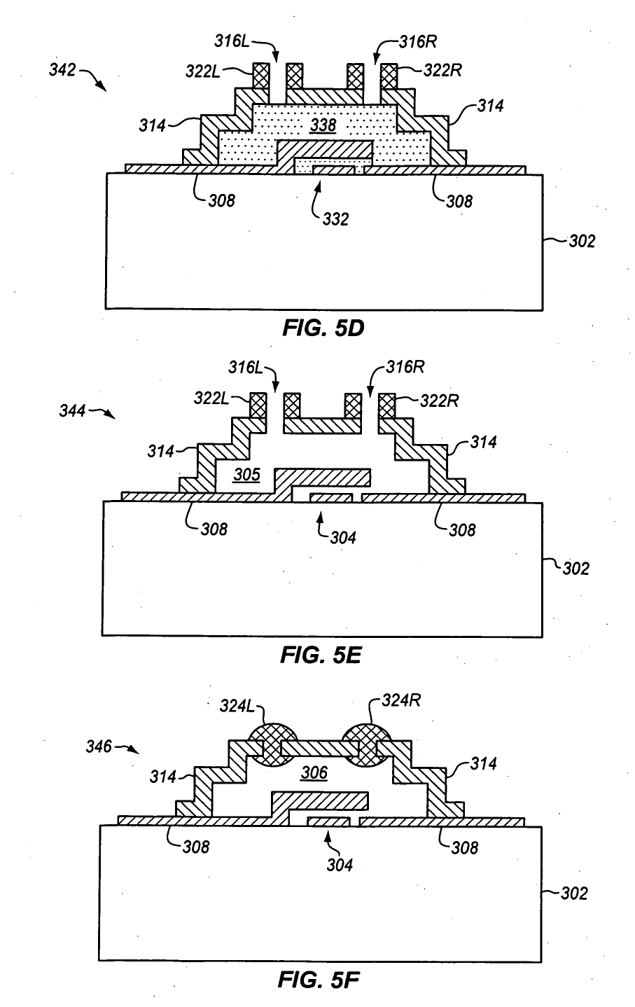

FIGS. 5A-5F show a method of making a microelectronic package, according to one or more embodiments of the invention. Each of FIGS. 5A-5F shows an enlarged cross-sectional view of an intermediate stage of the microelectronic package at a different stage in the method of manufacture.

FIG. 5A shows an enlarged cross-sectional view of an intermediate stage 330 having a device substrate 302 having interconnects 308 and an unreleased MEMS 332 formed thereon, according to one or more embodiments of the invention. The interconnects and the unreleased MEMS may be formed on the substrate by various approaches that are well-known in the arts. The MEMS is unreleased. In the illustrated embodiment, a sacrificial material 334 is included between a cantilever beam and a contact plate of the MEMS.

FIG. 5B shows a view of an intermediate stage 336 formed by depositing or otherwise forming a layer of sacrificial material 338 over the unreleased MEMS of the intermediate stage of FIG. 5A, according to one or more embodiments of the invention. The layer of sacrificial material may fully encase or encapsulate the unreleased MEMS. Examples of suitable methods of forming the layer of sacrificial material include, but are not limited to, PVD, CVD, and spin-on, to name just a few examples. The layer may optionally be patterned with lithography, although the scope of the invention is not limited in this respect. The layer of sacrificial material may include either the same material or a different material as the sacrificial material 334 of the unreleased MEMS.

FIG. 5C shows a view of an intermediate stage 340 formed by depositing or otherwise forming a cap layer 314 over the intermediate stage of FIG. 5B, according to one or more embodiments of the invention. The cap layer is formed over the layer of sacrificial material 338 and a peripheral, supported, sealing portion 315 of the cap layer is formed directly over the upper surface of the device substrate 302 to provide a seal with the device substrate. Examples of suitable methods of forming the cap layer include, but are not limited to, PVD, such as, for example, sputtering or evaporation, CVD, and spin-on, to name just a few examples. Other methods of forming layers known in the arts may alternatively optionally be used. The cap layer includes one or more sacrificial material removal openings, such as, for example, a left opening 316L and a right opening 316R. The cap layer may optionally be patterned with lithography, although the scope of the invention is not limited in this respect.

FIG. 5D shows a view of an intermediate stage 342 formed by forming a reflowable material 322L, 322R over the intermediate stage of FIG. 5C, according to one or more embodiments of the invention. As shown, in one or more embodiments of the invention, the reflowable material may optionally include multiple reflowable features, although the scope of the invention is not limited in this respect. In the illustrated embodiment, two reflowable features are shown, namely a left reflowable feature 322L and a right reflowable feature 322R. Each of the reflowable features is proximate a corresponding opening, although this is not required. As shown, in one or more embodiments of the invention, the reflowable features may optionally include rings, of various sizes and shapes, of reflowable material around a periphery of an opening or otherwise surrounding the opening, although the scope of the invention is not limited in this respect. In cross-section the rings are each illustrated as two rectangles. However the use of rings is not required. Other suitable reflowable features include, but are not limited to, groups or sets of discrete reflowable features around an opening. Still other suitable reflowable features include, but are not limited to, a single discrete reflowable feature, such as, for example, a solder ball or solder mound, at or around the side or edge of an opening. Yet another suitable reflowable feature includes a wall of solder material at or around at or around at least a portion of one or more sides or edges of an opening. These are just a few illustrative examples. The scope of the invention is not limited to just these examples.

As discussed above, in one or more embodiments of the invention, the reflowable material may include a metal reflowable material, such as, for example, a solder. Examples of suitable methods of forming solder features include, but are not limited to, plating, such as, for example, electroplating and/or electroless plating, printing, such as, for example, stencil printing, PVD, such as, for example, sputtering, solder dispensing, and direct solder ball placement.

Electroplating may optionally be used. By way of example, electroplating may include depositing a metal seed layer by sputtering or evaporation, depositing and patterning a resist layer with holes down to the seed material at locations where the solder features are intended to reside, and then plating solder material on the seed material within the holes in the patterned resist layer. The resist may serve as a sort of “mold” for the solder features.

Electroless plating or PVD may optionally be used. Alternatively, a similar approach may be used albeit using electroless plating or PVD to introduce the solder material into the mold holes in the patterned resist layer. In electroless plating and PVD the seed layer is not required.

Stencil printing may optionally be used. By way of example, stencil printing may include applying a solder paste through a stencil to deposit the solder over the substrate at locations determined by openings in the stencil.

Direct solder ball placement may optionally be used. By way of example, direct solder ball placement may include directly applying solder spheres to cap layer at appropriate locations. Often, the solder spheres may have a diameter in the range of about 50 to 250 micrometers, although this is not required. Suitable approaches for applying the solder spheres include, but are not limited to, those used in Surface Mount Technology and Ball Grid Array (BGA) packages.

As another option, in one or more embodiments of the invention, the reflowable material may include an indium and/or gallium alloy. Examples of suitable methods of forming such indium and/or gallium alloy features include, but are not limited to, printing, such as, for example, stencil printing, and dispensing, such as, for example, of the types used to dispense solder.

As yet another option, in one or more embodiments of the invention, the reflowable material may include a plastic reflowable material, such as, for example, a thermoplastic or a liquid crystal polymer. Examples of suitable methods of forming such plastic features include, but are not limited to, injection molding, transfer molding, spin casting, and directly applying prefabricated plastic components.

FIG. 5E shows a view of an unsealed microelectronic package 344 having one or more released MEMS 304 and an unsealed chamber 305 formed by removing sacrificial materials the intermediate stage of FIG. 5D, according to one or more embodiments of the invention. As shown, the sacrificial material has been removed from around the MEMS and between the device substrate and the cap layer. In one or more embodiments of the invention, a sacrificial material removal fluid, such as, for example, a gas, plasma, or liquid solvent or etchant, may be introduced through each of the sacrificial material removal openings to etch, dissolve, or otherwise remove the sacrificial material from around the minutely fabricated structures of the MEMS and from between the device substrate and the cap layer to from the chamber. The particular sacrificial material removal fluid used may depend upon the particular sacrificial material. For a copper sacrificial material, which is commonly used in MEMS fabrication, examples of suitable sacrificial material removal fluids include, but are not limited to, a variety of commercially available copper etchants. Another suitable sacrificial material and corresponding removal fluid therefor are silicon dioxide and hydrofluoric acid.

FIG. 5F shows a sealed microelectronic package 346 having a sealed chamber 306 formed by reflowing the reflowable material of the unsealed microelectronic package of FIG. 5E to seal the chamber, according to one or more embodiments of the invention. As shown, reflowed material 324L, 324R has closed the sacrificial material removal openings. In the illustrated embodiment, the reflowed material includes a left bead 324L and a right bead 324R of reflowed material. Each of the beads in included in and substantially fills a corresponding opening, although the scope of the invention is not limited in this respect. The beads are substantially centered about the center of the openings, although the scope of the invention is not limited in this respect.

Reflowing the material may include heating the material to increase the materials temperature. The material may be heated to a point, such as, for example, a temperature approaching, or at, or above, a reflow temperature. The reflow temperature may include a softening point temperature and/or a melting point temperature. At or above the reflow temperature, the reflowable material may begin to soften, melt, or otherwise reflow. As the reflowable material begins to reflow, the shape of the material may change like a liquid. Surface tension may tend to significantly affect the shape of the reflowed material and may tend to pull the material inwards on itself to form a sphereoid or bead. In some cases the reflowing material may move due to externally applied forces, such as, for example, gravity, or the like. In some cases gravity or surface tension or another force may be utilized to encourage the material into the sacrificial material removal opening. In one or more embodiments of the invention the reflowing material and the material of the cap layer may be wettable for one another in order to encourage the reflowing material to enter the opening. Surface treatments may optionally be used as desired. The material may be reflowed for a sufficient period of time for the fluid to reflow and close the sacrificial material removal openings. Often the period of time may range from several seconds to several minutes. After reflow, the material may be cooled to below the reflow temperature. As the material cools to significantly below the reflow temperature, the reflowed material may begin to harden and solidify. As the reflowed material solidifies, it may close and seal the chamber and the package.

In one or more embodiments of the invention, a reflow oven, such as, for example, a solder reflow oven, may be used to reflow the material. By way of example, the unsealed microelectronic package may be placed in the reflow oven, heated as described above, cooled, and then removed from the reflow oven. In one or more embodiments of the invention, the gas composition and/or pressure in the oven during reflow may be based, at least in part, on the desired gas composition and/or pressure in the sealed chamber, although this is not required. For example, in various embodiments of the invention, the gas composition in the oven may be enriched in an inert, such as, for example, nitrogen or a noble gas, and/or may be substantially dry, and the pressure in the oven may be substantially equal to a desired pressure in the sealed chamber. Reflow ovens are commercially available from numerous sources. However, the use of a reflow oven is not required. Examples of other suitable approaches, according to various embodiments of the invention, include, but are not limited to, heating the reflowable material by laser, acoustically, or by variable-frequency microwave.

Now, the invention is not limited to the particular embodiments described above. Many modifications and adaptations of the methods described above are contemplated. Operations may optionally be added to and/or removed from the method. As one example, in one or more embodiments, multiple sacrificial material removal operations may be included to release the MEMS and form the chamber. Operations may optionally be performed in different sequence than shown above. As one example, in one or more embodiments, reflowable material may be formed over the cap layer after the sacrificial material is removed. These are just a few examples. Additional modifications and/or adaptations may optionally be made.

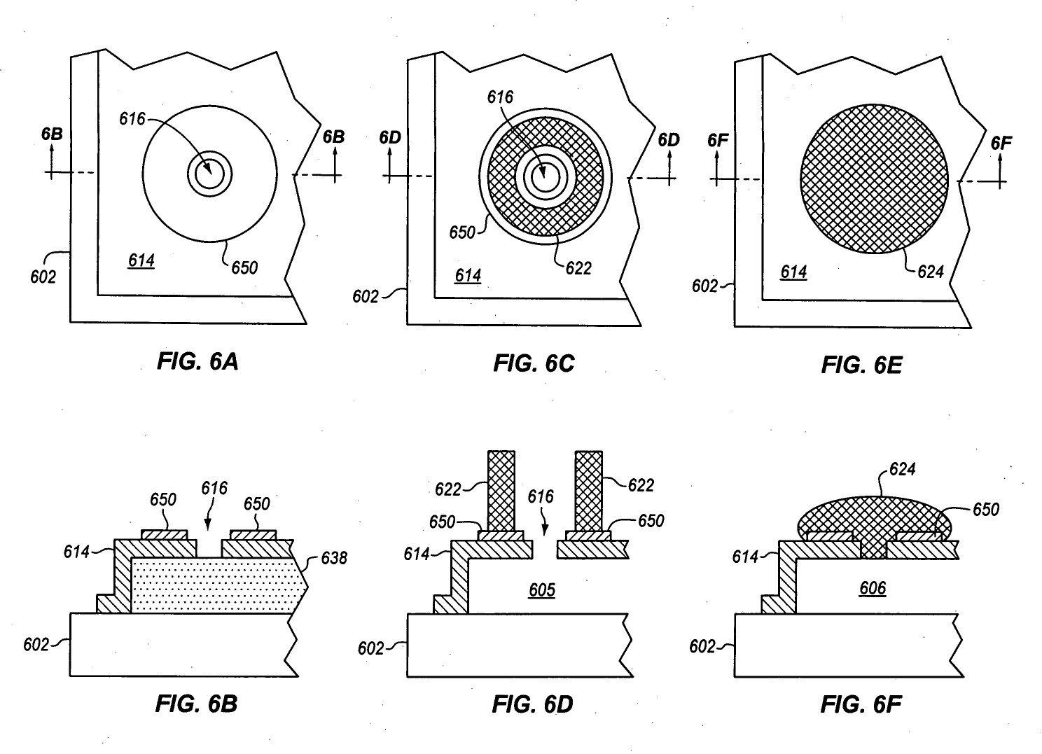

FIGS. 6A-6F show enlarged views of several stages of a method of making a microelectronic package in which a wettable pad is used to encourage a reflowed material to close an opening and seal a chamber, according to one or more embodiments of the invention.

FIGS. 6A-B show top-planar and cross-sectional views, respectively, of a first stage, according to one or more embodiments of the invention. As shown in the first stage, a device substrate 602 has a sacrificial material 638 thereon, and a cap layer 614 thereon. The cap layer has a sacrificial material removal opening 616.

A wettable pad 650 is formed over the cap layer. The wettable pad may include a material that is wettable by the reflowing material, or at least more wettable by the reflowing material than the cap layer. For example, in the case of solder, materials that are substantially wettable by solder include, but are not limited to, metals, such as, for example, gold or copper. Metals such as gold and copper tend to be more wettable than other materials, such as, for example, oxides of silicon and nitrides of silicon. Around the ring, the top surface of the cap layer may be at least somewhat less wettable by the reflowing material than the wettable pad.

As shown, the wettable pad may be proximate the opening. As best shown in the top-planar view, in one or more embodiments, the wettable pad may include a ring of wettable material around or surrounding a periphery of the opening, although the scope of the invention is not limited in this respect. In one or more embodiments of the invention, the wettable pad may be formed by forming a patterned layer over the cap layer, although this is not required. The wettable layer may optionally be relatively thin, although this is not required.

FIGS. 6C-D show top-planar and cross-sectional views, respectively, of a second stage, according to one or more embodiments of the invention. As shown in the second stage, a reflowable material 622, such as, for example, a solder, has been formed directly on the wettable pad 650. As best shown in the top-planar view, in one or more embodiments, the reflowable material may include a ring of reflowable material, such as, for example, solder, on the ring of wettable material, although the scope of the invention is not limited in this respect. As also shown in the second stage, the sacrificial material has been removed to create an unsealed chamber 605.

FIGS. 6E-F show top-planar and cross-sectional views, respectively, of a third and final stage, according to one or more embodiments of the invention. As shown in the third stage, the reflowable material has been reflowed to form a solidified reflowed material 624 to create a sealed chamber 606. As shown, the reflowed material substantially wets the wettable pad. The wettable pad may help to center the bead or sphereoid of reflowing material at the opening. The reflowable material may be included in a sufficient amount that when reflowed surface tension causes the reflowing material to form a single substantially void-free feature that wets the pad and closes the opening.

The use of a wettable pad may help to encourage good closure of the opening and sealing of the package. However the scope of the invention is not limited to including or using a wettable pad.

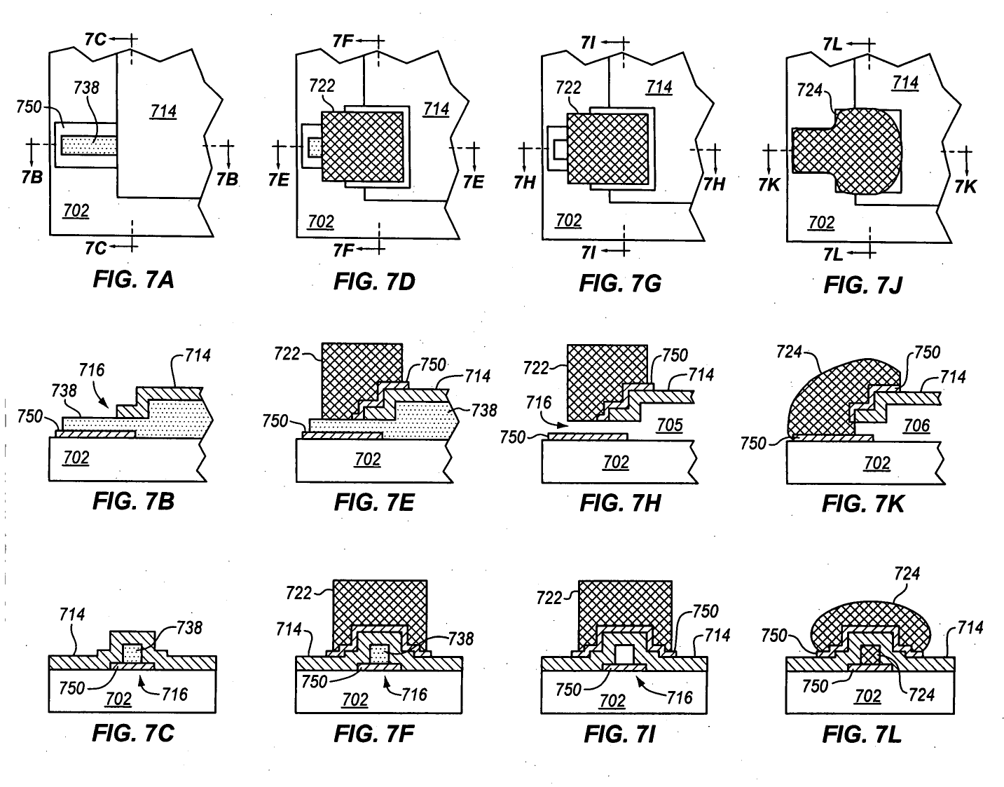

FIGS. 7A-7L show enlarged views of several stages of a method of making a microelectronic package in which a single tunnel sacrificial material removal opening may be closed by reflowing a single large reflowable feature so that it avalanches or collapses and closes the tunnel opening, according to one or more embodiments of the invention.

FIGS. 7A-C show top-planar, front cross-sectional, and side cross-sectional views, respectively, of a first stage, according to one or more embodiments of the invention. As shown in the first stage, a device substrate 702 has a wettable pad 750 thereon, a sacrificial material 738 thereon, and a cap layer 714 thereon. As best shown in the view of FIG. 7C, a small tunnel opening 716, for example of square or rectangular cross section, may be included into an intended location of a chamber between the device substrate and the cap layer.

FIGS. 7D-F show top-planar, front cross-sectional, and side cross-sectional views, respectively, of a second stage, according to one or more embodiments of the invention. As shown in the second stage, an additional wettable pad 750 may be formed over the cap layer at a location appropriate to support a portion of a reflowable feature, and then the reflowable feature 722, such as, for example, a single relatively large portion of solder, maybe formed over at least a portion of the recently formed wettable pad. As shown best shown in the view of FIG. 7E, a portion of the reflowable material may optionally be formed over the sacrificial material in front of the sacrificial material removal opening. This may encourage the reflowable material to fall or avalance in front of the opening during reflow, although this is not required.

FIGS. 7G-I show top-planar, front cross-sectional, and side cross-sectional views, respectively, of a third stage, according to one or more embodiments of the invention. As shown in the third stage, the sacrificial material of the second stage has been removed to form an unsealed chamber 705. Notice in the view of FIG. 7H that reflowable material may optionally be included over the sacrificial material removal opening 716, so that reflowable material overhangs the opening. This may encourage closure of the opening during reflow, but is not required.

FIGS. 7J-L show top-planar, front cross-sectional, and side cross-sectional views, respectively, of a fourth stage, according to one or more embodiments of the invention. As best shown in the views of FIGS. 7K-L, the reflowable material has been reflowed to close the sacrificial material removal opening and create a sealed chamber 706. Reflow of the material has, at least in concept, caused an avalanche of the reflowable material, which has closed the tunnel and sealed the chamber.

Alternate embodiments are also contemplated. For example, in an alternate embodiment, two or more tunnels may be employed. In another alternate embodiment, multiple reflowable features may be used to seal a tunnel. In yet another embodiment, a tunnel to the chamber may be created directly through reflowable material and then the reflowable material may be reflowed to collapse the tunnel therein. In a still further alternate embodiment, a reflowable feature may be made external to the etch tunnel, and upon reflow, the material may be encouraged to move toward the entrance to the tunnel, such as, for example, due to surface tension. These are just a few examples. Other embodiments will be contemplated by those skilled in the art and having the benefit of the present disclosure.

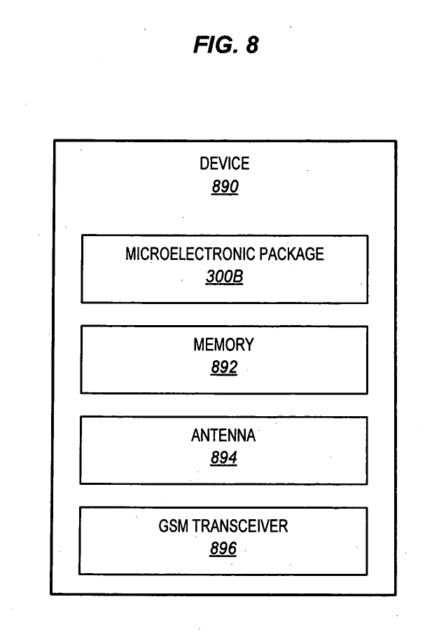

The microelectronic packages disclosed herein may be included and employed in a wide variety of electronic devices. FIG. 8 shows an electronic device 890, such as, for example, a wireless device, according to one or more embodiments of the invention. The wireless device may include a cellular phone, personal digital assistant (PDA), or a laptop computer, to name just a few examples.

The electronic device includes a microelectronic package 300B. The package may have any one or more of the characteristics of the packages described elsewhere herein. In one or more embodiments of the invention, the package may be employed as a front-end package or module, or a smart antenna, for example, for a wireless device supporting a cellular, wireless local area network (WLAN), or ultrawideband (UWB) standard, for example. The package may include one or more MEMS, such as, for example one or more switches. The switch(s) may turn on-or-off or select various filters for different frequencies, for example.

The electronic device also includes a memory 892, an antenna 894, and a GSM (Global System for Mobile communications) transceiver 896. In alternate embodiments the electronic device may include any one or any two of these aforementioned components. Examples of suitable memory each included in some but not all electronic devices include, but are not limited to, SRAM, DRAM, Flash, PROM, EPROM, EEPROM. In one or more embodiments of the invention, Flash memory may be used. Examples of suitable antennas each included in some but not all electronic devices include, but are not limited to, omnidirectional antennas and dipole antennas. GSM transceivers are likewise included in some, but not all, electronic devices, including in some, but not all, wireless devices. The GSM transceiver may allow the apparatus to utilize CDMA (Code Division Multiple Access), TDMA (Time Division Multiple Access), and/or W-CDMA (Wideband Code Division Multiple Access) communications, for example.

In the description above, for the purposes of explanation, numerous specific details have been set forth in order to provide a thorough understanding of the embodiments of the invention. Other embodiments may be practiced without some of these specific details. In other instances, well-known circuits, structures, devices, and techniques have been shown in block diagram form or without detail in order not to obscure the understanding of this description.

Many of the methods are described in their most basic form, but operations may be added to or deleted from the methods. Many further modifications and adaptations may be made. The particular embodiments are not provided to limit the invention but to illustrate it. The scope of the invention is not to be determined by the specific examples provided above but by the claims below.

In the claims, any element that does not explicitly state “means for” performing a specified function, or “step for” performing a specified function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

It should also be appreciated that reference throughout this specification to “one embodiment” or “an embodiment” or “one or more embodiments” means that a particular feature may be included in the practice of the invention. Similarly, it should be appreciated that in the foregoing description of exemplary embodiments of the invention, various features are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

While the invention has been described in terms of several embodiments, the invention is not limited to the embodiments described, but may be practiced with modification and alteration within the spirit and scope of the appended claims. The description is thus to be regarded as illustrative instead of limiting.

What is claimed is:

1. An apparatus comprising:
a substrate;
a cap layer over the substrate;
a sealed chamber defined between the substrate and the cap layer;
one or more openings to the sealed chamber that are closed by a reflowed material;
one or more minutely fabricated structures coupled with the substrate within the sealed chamber; and
one or more interconnect to couple the one or more minutely fabricated structures with a signaling medium that is external to the sealed chamber.

2. The apparatus of claim 1, wherein the reflowed material is selected from the group consisting of a reflowed metal and a reflowed plastic.

3. The apparatus of claim 2, wherein the reflowed material comprises solder.

4. The apparatus of claim 1, wherein the one or more openings comprise a plurality of openings through the cap layer, and wherein the reflowed material comprises discrete reflowed material closing each of the plurality of openings.

5. The apparatus of claim 1, wherein the one or more openings comprise a tunnel, and wherein the reflowed material comprises collapsed reflowed material that closes the tunnel.

6. The apparatus of claim 1, wherein the one or more minutely fabricated structures comprise one or more microelectromechanical systems (MEMS).

7. The apparatus of claim 1, further comprising a wettable pad directly under a reflowed material.

8. The apparatus of claim 7, wherein the wettable pad has a shape of a ring around an opening.

9. The apparatus of claim 1, wherein interconnect material beneath the cap layer is buried in an insulating material.

10. An apparatus comprising:
a substrate;
a cap layer over the substrate;
an unsealed chamber defined between the substrate and the cap layer;
one or more openings into the unsealed chamber;
reflowable material over the cap layer proximate the one or more openings;
one or more minutely fabricated structures coupled with the substrate within the unsealed chamber; and
interconnects to couple the one or more minutely fabricated structures with a signaling medium that is external to the unsealed chamber.

11. The apparatus of claim 10, wherein the reflowable material is selected from the group consisting of a reflowable metal and a reflowable plastic.

12. The apparatus of claim 11, wherein the reflowable material comprises solder.

13. The apparatus of claim 10, wherein the one or more openings comprise one or more openings in the cap layer, and wherein the reflowable material comprises one or more corresponding reflowable features over the cap layer around a periphery of each of the one or more openings in the cap layer.

14. The apparatus of claim 10, wherein the one or more openings comprise a tunnel, and wherein the reflowable material comprises reflowable material over the tunnel.

15. The apparatus of claim 10, further comprising a wettable pad under the reflowable material.

16. A method comprising:
releasing one or more microfabricated structures and forming an unsealed chamber by removing sacrificial material through one or more openings with a sacrificial material removal fluid;
sealing the unsealed chamber by closing the one or more openings by reflowing material.

17. The method of claim 16, wherein reflowing the material comprises heating the material to a reflow temperature.

18. The method of claim 16, further comprising:
forming a wettable pad proximate an opening; and
forming a reflowable material directly on the wettable pad.

19. A system comprising:
a flash memory;
an omnidirectional antenna coupled with the flash memory;
a package coupled with the flash memory, the package including:
a substrate, a layer over the substrate, and a sealed chamber defined between the substrate and the layer;
one or more openings to the sealed chamber that are closed by a material selected from the group consisting of a solder, an alloy of indium, an allow of gallium, a liquid crystal polymer, a thermoplastic, and combinations thereof;
one or more microelectromechanical systems (MEMS) coupled with the substrate within the sealed chamber; and
one or more interconnect to couple the one or more MEMS with a signaling medium that is external to the sealed chamber.

20. The system of claim 19, wherein the material comprises solder.

21. The system of claim 19, further comprising a wettable pad directly under the material.

22. The system of claim 19, wherein the one or more openings comprise a tunnel, and wherein the material comprises material that has collapsed to close the tunnel.
